(19) United States
(12) Patent Application Publication
(10) Pub. No.: US 2018/0316016 A1
(43) Pub. Date: Nov. 1, 2018

(54) COATING LIQUID FOR CATHODE ACTIVE MATERIAL, METHOD FOR MAKING THE SAME, AND METHOD FOR COATING CATHODE ACTIVE MATERIAL

(71) Applicant: Tsinghua University, Beijing (CN)

(72) Inventors: XIANG-MING HE, Beijing (CN); YING-QIANG WU, Suzhou (CN); LI WANG, Beijing (CN)

(73) Assignee: Tsinghua University, Beijing (CN)

(21) Appl. No.: 16/028,417

(22) Filed: Jul. 6, 2018

Related U.S. Application Data
(63) Continuation of application No. PCT/CN2016/113558, filed on Dec. 30, 2016.

(30) Foreign Application Priority Data
Jan. 8, 2016 (CN) 201610011571.4

(51) Int. Cl. H01M 4/62; C09D 1/00; C09D 5/00; H01M 4/36; H01M 10/0525

(52) U.S. Cl. CPC H01M 4/628; C09D 1/00; H01M 2004/028; H01M 4/366; H01M 10/0525; C09D 5/00

(57) ABSTRACT

The present disclosure provides a coating liquid for a cathode active material comprising a solvent and a phosphate salt coating precursor dissolved in the solvent. The solvent includes an alcoholic solvent. The coating precursor is capable of producing the phosphate salt under heating. The phosphate salt has a general formula of AlₘMₙPO₄, wherein M has a valence state of k and is selected from one or more alkaline earth metal elements and transition metal elements, 0≤m≤1, 0<n≤1, and 3m+kn=3. A method for making the coating liquid and a method for coating the cathode active material are also provided.

### CROSS-REFERENCE TO RELATED APPLICATIONS

This application claims all benefits accruing under 35 U.S.C. § 119 from China Patent Application No. 201610011571.4, filed on Jan. 8, 2016 in the State Intellectual Property Office of China, the content of which is hereby incorporated by reference. This application is a continuation under 35 U.S.C. § 120 of international patent application PCT/CN2016/113558 filed on Dec. 30, 2016, the content of which is also hereby incorporated by reference.

### FIELD

The present disclosure relates to a coating liquid for a cathode active material, a method for making the coating liquid, and a method for coating the cathode active material.

### BACKGROUND

Coating surfaces of cathode active material particles is a common method to modify a cathode active material of a lithium ion battery. For example, a carbon layer can be coated on surfaces of lithium iron phosphate particles to improve the conductivity of lithium iron phosphate. In another example, aluminum phosphate can be coated on surfaces of the cathode active material particles (such as lithium cobalt oxide particles) to improve the thermal stability of a cathode of the lithium ion battery (referring to “Correlation between AlPO₄ nanoparticle coating thickness on LiCoO₂ cathode and thermal stability.” J. Cho, Electrochimica Acta 48 (2003) 2807-2811 and U.S. Pat. No. 7,326,498).

A conventional method to coat the aluminum phosphate on the surface of the cathode active material includes: dispersing aluminum phosphate particles in water to obtain a dispersion liquid, adding the cathode active material particles to the dispersion liquid so that the aluminum phosphate particles are adsorbed on the surfaces of the cathode active material particles due to adsorption effect, removing the water from the dispersion liquid, and heating the resultant solid at about 700° C., thereby obtaining the cathode active material with the aluminum phosphate particles on the surface thereof. However, because the aluminum phosphate is insoluble in water, the aluminum phosphate coating layer formed on the surface of the cathode active material by the above method is not uniform, resulting in a relatively poor cycling performance of the lithium ion battery.

### SUMMARY

What is needed therefore is to provide a coating liquid for a cathode active material, a method for making the coating liquid, and a method for coating the cathode active material.

One aspect of the present disclosure includes a coating liquid for a cathode active material. The coating liquid comprises a solvent and a phosphate salt coating precursor soluble to the solvent. A phosphate salt is capable of being produced by heating the phosphate salt coating precursor. The phosphate salt has a molecular formula of AlₘMₙPO₄, wherein M has a valence state of k, and M is one or more elements selected from alkaline earth metal elements and transition metal elements, 0≤m<1, 0<n≤1, and 3m+kn=3.

Another aspect of the present disclosure includes a coating liquid for a cathode active material. The coating liquid is a homogeneous clear solution comprising a mixture of a phosphate ester, an aluminum salt, a modifying element containing compound, and an alcoholic solvent; or comprising a mixture of at least one of phosphoric acid and phosphorus pentoxide, the aluminum salt, the modifying element containing compound, and the alcoholic solvent.

Another aspect of the present disclosure includes a method for making the coating liquid for the cathode active material, the method comprising: forming a phosphate ester solution by adding a phosphate ester in an alcoholic solvent; and adding an aluminum salt and a modifying element containing compound in the phosphate ester solution, wherein the aluminum salt and the modifying element containing compound are soluble to the alcoholic solvent, and react with the phosphate ester to form a homogeneous clear solution.

Another aspect of the present disclosure includes a method for coating the cathode active material, the method comprising: forming a phosphate ester solution by adding a phosphate ester in an alcoholic solvent; adding an aluminum salt and a modifying element containing compound in the phosphate ester solution, wherein the aluminum salt and the modifying element containing compound are soluble to the alcoholic solvent, and react with the phosphate ester to form the coating liquid for the cathode active material; uniformly mixing the cathode active material with the coating liquid to obtain a solid-liquid mixture; and drying and sintering the solid-liquid mixture to obtain a cathode composite material, wherein the cathode composite material comprises the cathode active material and a coating layer coated on a surface of the cathode active material.

Since the coating liquid for the cathode active material of the present disclosure is a homogeneous clear solution, it is easy to form a thin, uniform, and continuous coating layer on each cathode active material particle, and each cathode active material particle can be completely covered by the coating layer, thereby preventing side reactions between the cathode active material and electrolyte liquid, and improving thermal stability and capacity retention performance of the lithium ion battery. In addition, since the thickness of the coating layer is small, the electrochemical performance of the lithium ion battery is not reduced.

### BRIEF DESCRIPTION OF THE DRAWINGS

Implementations are described by way of example only with reference to the attached figures.

FIG. 1 is a flow chart of one embodiment of a method for making a coating liquid for a cathode active material and coating the cathode active material.

FIG. 2 is a flow chart of another embodiment of the method for making the coating liquid for the cathode active material.

FIG. 3 is a graph showing X-ray diffraction (“XRD”) spectrums of embodiments of coating layers obtained by sintering at 400° C.

FIG. 4 a graph showing charging and discharging voltage curves of one embodiment of a lithium ion battery using a coated cathode active material.

FIG. 5 is a graph showing charging and discharging voltage curves of a lithium ion battery using an uncoated cathode active material.

FIG. 6 is a graph showing a comparison between cycling performances of the lithium ion batteries using the coated cathode active material and uncoated cathode active material.

FIG. 7 is a graph showing temperature-voltage curves of the lithium ion batteries using the coated cathode active material and uncoated cathode active material.

### DETAILED DESCRIPTION

A detailed description with the above drawings is made to further illustrate the present disclosure.

One embodiment of a coating liquid for a cathode active material is disclosed, and the coating liquid includes a solvent and a phosphate salt coating precursor. The coating precursor is soluble to the solvent. The coating liquid can be a homogeneous clear solution. The coating precursor can be completely dissolved in the solvent. The solvent can at least include an alcoholic solvent, and can further include a second solvent that is miscible with the alcoholic solvent.

The phosphate salt coating precursor can be heated to produce a phosphate salt. The phosphate salt can have a molecular formula of AlₘMₙPO₄, wherein M is a modifying element having a valence state of k. M can be one or more elements selected from alkaline earth metal elements and transition metal elements. In one embodiment, M can be selected from trivalent Cr, trivalent Fe, bivalent Sn, bivalent Ni, bivalent Co, bivalent Cu, bivalent Mn, tetravalent Zr, tetravalent Ti, or combinations thereof. In the molecular formula, 0≤m<1, 0<n≤1, and 3m+kn=3. It should be noted that when M represents two or more elements, kn refers to a sum of each product of valence state and atomicity of each metal element. A molar ratio of P to a sum of Al and M can be in a range from about 4:3 to about 2:3, that is, P:(Al+M)=4:3-2:3. In one embodiment, the coating precursor can be heated at a temperature greater than 300° C. to obtain the phosphate salt.

In one embodiment, the phosphate salt can be at least one of (Al₁₋ₓMg_{x/2}Ti_{x/2})PO₄ wherein 0<x≤1, (Al_{1-y}Mg_{3y/2})PO₄, wherein 0<y≤1, (Al_{1-z}Ti_{3z/4})PO₄, wherein 0<z≤1.

In one embodiment, the solvent in the coating liquid for the cathode active material can consist of an organic solvent, such as the alcoholic solvent. In another embodiment, the solvent in the coating liquid for the cathode active material can be a combination of the organic solvent and water, such as a combination of the alcoholic solvent and water. In one embodiment, the water in the solvent comes only from crystal water of raw materials for synthesizing the phosphate salt coating precursor.

In one embodiment, the phosphate salt coating precursor can include at least one of a first coordination complex represented by the following general formula (I-I) and a second coordination complex represented by the following general formula (I-II):

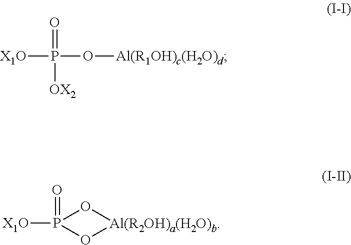

R₁OH and R₂OH are alcoholic solvent molecules and each can be independently selected from methanol, ethanol, propanol, n-butanol, isopropanol, or combinations thereof. c can be 1 to 5, d can be 0 to 4, and c+d=5. a can be 1 to 4, b can be 0 to 3, and a+b=4. Thus, each aluminum atom can be respectively coordinated with at least one alcoholic solvent molecule and each aluminum atom can be respectively coordinated with a water molecule. —OX₁ and —OX₂ can be, each independently, —OH or alkoxy corresponding to the alcoholic solvent molecule. In one embodiment, —OX₁ and —OX₂ can each be independently selected from —OH, methoxy, ethoxy, propoxy, butoxy, isopropoxy, or combinations thereof.

In another embodiment, the phosphate salt coating precursor can include at least one of a third coordination complex and a fourth coordination complex. General formulas of the third coordination complex and the fourth coordination complex are respectively substantially the same as the general formula (I-I) and the general formula (I-II), except that Al in the general formula (I-I) and the general formula (I-II) are substituted by the modifying element M.

A mass percent of the phosphate salt coating precursor in the coating liquid can be in a range from about 0.5% to about 15%.

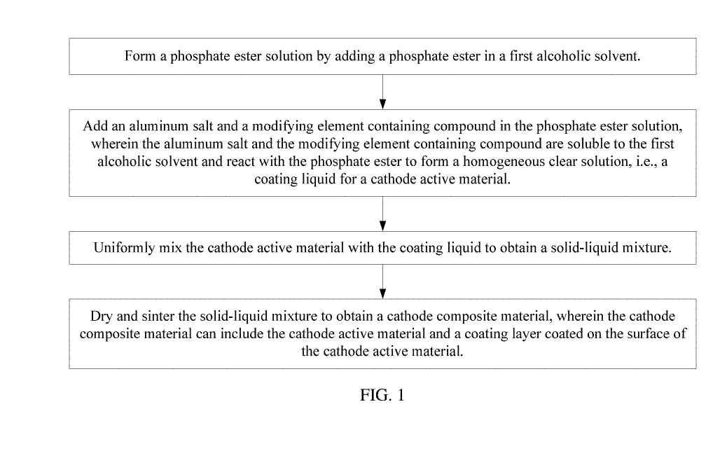

Referring to FIG. 1, a first embodiment of a method for making the coating liquid for the cathode active material includes:

S1, forming a phosphate ester solution by adding a phosphate ester in the first alcoholic solvent; and

S2, adding an aluminum salt and a modifying element containing compound in the phosphate ester solution, wherein the aluminum salt and the modifying element containing compound are soluble to the first alcoholic solvent and react with the phosphate ester to form the homogeneous clear solution, i.e., the coating liquid for the cathode active material.

The first alcoholic solvent can be selected from methanol, ethanol, propanol, n-butanol, isopropanol, or combinations thereof.

The phosphate ester can have a general formula of A_{g}P(O)(OH)_{q}, wherein A can be an alkoxy corresponding to the alcoholic solvent molecule. In one embodiment, A can be selected from methoxy, ethoxy, propoxy, butoxyl, isopropoxy, or combinations thereof. g can be 1 to 3, q can be 0 to 2, and g+q=3. In one embodiment, the phosphate ester can be selected from monomethyl phosphate, dimethyl phosphate, trimethyl phosphate, monoethyl phosphate, diethyl phosphate, triethyl phosphate, monobutyl phosphate, dibutyl phosphate, tributyl phosphate, monoisopropyl phosphate, di-isopropyl phosphate, tri-isopropyl phosphate, or combinations thereof.

A mass ratio of the phosphate ester to the first alcoholic solvent can be in a range from about 1:1 to about 1:50.

S1 can further include:

adding at least one of phosphoric acid and phosphorus pentoxide into the first alcoholic solvent; and

forming the phosphate ester by reacting the at least one of phosphoric acid and phosphorus pentoxide with the first alcoholic solvent at a temperature in a range from about 0° C. to about 80° C.

The first alcoholic solvent can be excessive so that the at least one of phosphoric acid and phosphorus pentoxide can be completely reacted. In one embodiment, a mass ratio of the phosphoric acid and/or phosphorus pentoxide to the first alcoholic solvent can be in a range from about 1:1 to about 1:50.

In one embodiment, the phosphorus pentoxide can react with ethanol as in the following reaction equation (II-I) and reaction equation (II-II):

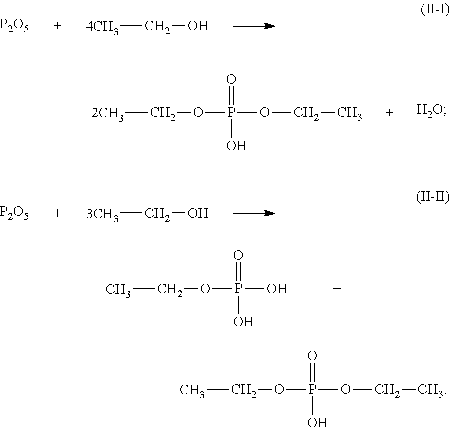

The aluminum salt can be an alcohol-soluble aluminum salt and aluminum ions can be dissociated in the first alcoholic solvent. In one embodiment, the aluminum salt can be selected from aluminum chloride, aluminum nitrate, aluminum isopropoxide, aluminum lactate, or combinations thereof. A mass ratio of the alcohol-soluble aluminum salt to the first alcoholic solvent can be in a range from about 1:1 to about 1:50. A molar ratio of phosphorus element in the phosphate ester to aluminum element in the alcohol-soluble aluminum salt can be about 1:1. The aluminum salt may or may not have crystal water.

The modifying element containing compound can be an alcohol-soluble compound, and ions of the modifying element M can be dissociated in the first alcoholic solvent. The modifying element M can be selected from one or more of alkaline earth metal elements and transition metal elements. In one embodiment, the modifying element M can be selected from trivalent Cr, trivalent Fe, bivalent Sn, bivalent Ni, bivalent Co, bivalent Cu, bivalent Mn, tetravalent Zr, tetravalent Ti, or combinations thereof. The alcohol-soluble modifying element containing compound can be selected from magnesium nitrate, nickel nitrate, manganese nitrate, cobalt nitrate, magnesium acetate, nickel acetate, cobalt acetate, manganese acetate, zinc chloride, copper nitrate, tetrabutyl zirconate, tetrabutyl titanate, or combinations thereof. A molar ratio of the modifying element containing compound to the alcohol-soluble aluminum salt can be in a range from about 10:1 to about 1:10. The modifying element containing compound can be added in the phosphate ester solution together with the aluminum salt. A molar ratio of P in the phosphate ester to a total of Al in the aluminum salt and M in the modifying element containing compound, i.e., P:(Al+M), can be in a range from about 4:3 to about 2:3. The modifying element containing compound may or may not have crystal water.

In the reaction between the aluminum salt and the phosphate ester in the first alcoholic solvent, aluminum ions are reacted with hydroxyl group of the phosphate ester to form a P—O—Al structure, and the aluminum ions are coordinated with the molecule of the first alcoholic solvent due to ionic salvation to form a coordination complex. The modifying element containing compound can be also reacted with the phosphate ester, during which a P—O-M structure can be formed, and the modifying element M can be coordinated with the molecule of the first alcoholic solvent. In one embodiment, a reaction temperature in S2 can be in a range from about 20° C. to about 80° C. A reaction time in S2 can be in a range from about 30 minutes to about 10 hours. When q in the general formula of A_{g}P(O)(OH)_{q} is 0, that is the phosphate ester has three ester groups, the phosphate ester can be hydrolyzed by the crystal water contained in the aluminum salt and/or the modifying element containing compound to generate the hydroxyl group, so that the above described reaction can proceed.

In one embodiment, S2 includes:

S21, adding the aluminum salt and the modifying element containing compound together in a second alcoholic solvent, thereby obtaining a mixture solution containing the aluminum salt and the modifying element containing compound; and

S22, mixing the mixture solution with the phosphate ester solution obtained in S1 to react the aluminum salt and the modifying element containing compound with the phosphate ester to form the homogeneous clear solution.

In one embodiment, the phosphate ester can react with the aluminum ions in the mixture solution as in the following reaction equation (II-III) and reaction equation (II-IV):

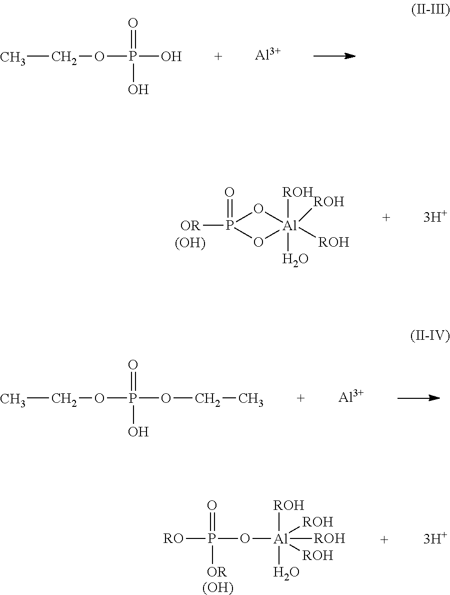

In another embodiment, the phosphate ester can react with the ions of the modifying element M in the mixture solution as in reaction equations respectively substantially same as the equation (II-III) and equation (II-IV), except that Al is substitute by M.

Since water has negative effects on the performance of certain cathode active materials, such as high nickel content ternary cathode active materials and a lithium cobalt oxide, there is no water in some embodiments of the coating liquid, or the water contained in the coating liquid comes only from crystal water of the raw material such as the aluminum salt and/or the modifying element containing compound. In one embodiment, none of the phosphate ester solution, the mixture solution, and the homogeneous clear solution contains water, and the solvent is only an organic solvent. In another embodiment, the solvent in the phosphate ester solution, the mixture solution, and the homogeneous clear solution contains water only from the crystal water of the aluminum salt and/or the modifying element containing compound. In addition, the non-aqueous coating liquid can have a smaller viscosity and a smaller surface tension, so that the coating layer on a surface of the cathode active material can be more uniform.

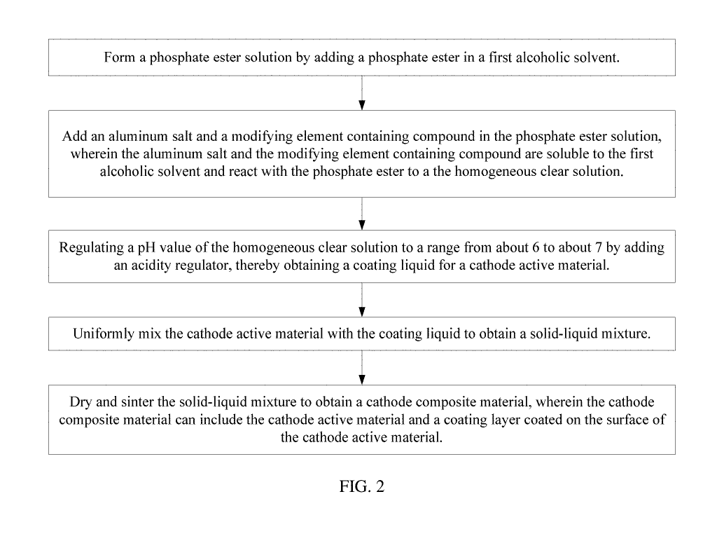

Referring to FIG. 2, a second embodiment of a method for making the coating liquid for the cathode active material includes:

S1, forming a phosphate ester solution by adding a phosphate ester in the first alcoholic solvent; and

S2, adding an aluminum salt and a modifying element containing compound in the phosphate ester solution, wherein the aluminum salt and the modifying element containing compound are soluble to the first alcoholic solvent and react with the phosphate ester to form the homogeneous clear solution; and

S20, regulating a pH value of the homogeneous clear solution to a range from about 6 to about 7 by adding an acidity regulator, thereby obtaining the coating liquid.

S1 and S2 of the second embodiment are respectively substantially the same as S1 and S2 of the first embodiment. The method of the second embodiment further includes S20 to obtain the coating liquid with the pH value ranging from about 6 to about 7.

More specifically, S20 can include:

weighing the acidity regulator according to the stoichiometric ratio; and

adding the acidity regulator to the homogeneous clear solution portion by portion, during which the homogeneous clear solution is continuously stirred to disperse the acidity regulator till all weighted acidity regulator is added into the homogeneous clear solution. It should be understood than the pH value of the coating liquid should not be too high. The coating precursor easily decomposes to form precipitate in an alkaline environment which makes the coating liquid unstable and not clear. By adding the acidity regulator to the homogeneous clear solution portion by portion, and stirring the homogeneous clear solution continuously, a regional excess of the acidity regulator can be avoided.

Too strong an acidity of the coating liquid may lead to dissolution of active components in some cathode active materials, thereby deteriorating the performance and destroying structural stability of the cathode active material. By regulating the coating liquid to be close to neutral, the negative influence of the acidic solution to the cathode active material can be effectively reduced. The acidity regulator can be ammonia water, ammonium bicarbonate, ammonium carbonate, ammonium acetate, pyridine, triethylamine, or combinations thereof. A total amount of the acidity regulator that is added can be in accordance with the amount of the aluminum salt to have a molar ratio of the nitrogen element contained in the acidity regulator to the aluminum element contained in the aluminum salt (N:Al) being in a range from about 1:1 to about 6:1.

One embodiment of a method for coating the cathode active material by using the coating liquid includes:

S3, uniformly mixing the cathode active material with the coating liquid to obtain a solid-liquid mixture; and

S4, drying and sintering the solid-liquid mixture to obtain a cathode composite material, wherein the cathode composite material can include the cathode active material and a coating layer coated on the surface of the cathode active material.

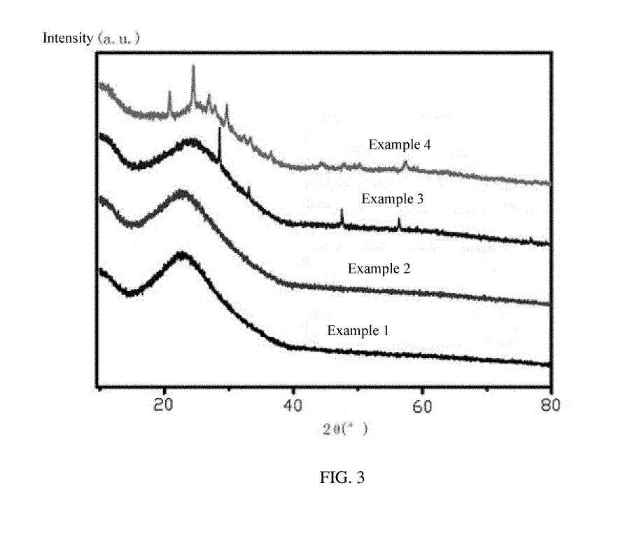

Referring to FIG. 3, in one embodiment, the modifying element M includes Mg and Ti. A product is obtained by drying and sintering the coating liquid at 400° C. The XRD spectrum of the product shown in FIG. 3 proves that the coating layer is amorphous (Al₁₋ₓMg_{x/2}Ti_{x/2})PO₄.

A mass percent of the coating layer in the cathode composite material can be in a range from about 0.3% to about 5%. A thickness of the coating layer can be in a range from about 5 nm to about 100 nm.

The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide.

In S3, a liquid thin film of the coating liquid can be formed on the surface of the cathode active material. In one embodiment, the cathode active material and the coating liquid are mixed uniformly and then filtered to create the solid-liquid mixture in a slurry state in which most of the coating liquid is coated on the surface of the cathode active material, which is beneficial to obtain the cathode composite material with a relatively thin coating layer coated on the surface of the cathode active material.

In S4, the solid-liquid mixture can be naturally dried at room temperature or heated, such as at about 30° C. to about 100° C., as long as the solvent of the solid-liquid mixture can be removed. The sintering can be performed in air, so that organic groups in the coating precursor can be removed to form the coating layer. A sintering temperature can be in a range from about 300° C. to about 800° C., such as 400° C. A sintering time can be in a range from about 3 hours to about 8 hours.

Since the coating liquid for the cathode active material of the present disclosure is a homogeneous clear solution, it is easy to form the thin, uniform, and continuous coating layer on each cathode active material particle, and each cathode active material particle can be completely covered by the coating layer, thereby preventing side reactions between the cathode active material and the electrolyte liquid, and improving the thermal stability and capacity retention performance of the lithium ion battery. In addition, the since the thickness of the coating layer is small, electrochemical performance of the lithium ion battery is not reduced. Furthermore, when the modifying element M is contained in the coating layer, aluminum can be partially substituted by the modifying element M, so that synergy effect of various kinds of metal ions can be generated to improve the electrochemical performance of the cathode composite material.

### Example 1

Phosphorus pentoxide and ethanol are mixed in a molar ratio of 1:10 and stirred at room temperature to obtain a phosphate ester solution, during which phosphorus pentoxide is completely transformed into phosphate ester. Aluminum nitrate, magnesium acetate, and tetrabutyl titanate are dissolved in ethanol in a mole ratio of 8:1:1 to obtain a metal salt solution. The phosphate ester solution and the metal salt solution are mixed and stirred at 50° C. to obtain a homogeneous clear coating liquid for a cathode active material, wherein a mole ratio of P to M (metal element of the metal salt, comprising Al, Mg, and Ti) is about 1:1

The coating liquid and the cathode active material LiNi_{1/3}Co_{1/3}Mn_{1/3}O₂ are mixed in a mass ratio of 1:5 to 1:2 to obtain a solid-liquid mixture. The solid-liquid mixture is filtered to remove redundant liquid, and sintered at 400° C. in air to obtain a cathode composite material. A lithium ion battery is assembled by using the cathode active material. The electrolyte liquid of the lithium ion battery is 1.0 mol L⁻¹ of LiPF₆ (EC/EMC=3:7, mass ratio). The anode of the lithium ion battery is lithium metal. The charging and discharging performance of the lithium ion battery is tested.

The coating liquid is dried at 60° C. and sintered at 400° C. in air to obtain a product which is (Al_{0.8}Mg_{0.1}Ti_{0.1})PO₄, and the XRD spectrum of the product is shown in FIG. 3.

### Example 2

Example 2 is substantially the same as the Example 1, except that a molar ratio of aluminum nitrate, magnesium acetate, and tetrabutyl titanate is 6:2:2. FIG. 3 shows the XRD spectrum of the product obtained by drying and sintering the coating liquid, revealing that the product is (Al_{0.6}Mg_{0.2}Ti_{0.2})PO₄.

### Example 3

Example 3 is substantially the same as the Example 1, except that a molar ratio of aluminum nitrate, magnesium acetate, and tetrabutyl titanate is about 1:1:1. FIG. 3 shows the XRD spectrum of the product obtained by drying and sintering the coating liquid, revealing that the product is (Al_{0.33}Mg_{0.33}Ti_{0.33})PO₄.

### Example 4

Example 4 is substantially the same as the Example 1, except that aluminum nitrate is not used, and a molar ratio of magnesium acetate to tetrabutyl titanate is 1:1. FIG. 3 shows the XRD spectrum of the product obtained by drying and sintering the coating liquid, revealing that the product is (Mg_{0.5}Ti_{0.5})PO₄.

### Comparative Example 1

A lithium ion battery is assembled by using the uncoated cathode active material LiNi_{1/3}Co_{1/3}Mn_{1/3}O₂. Other components of the lithium ion battery and test conditions of the charging and discharging performance are the same as that of Example 1.

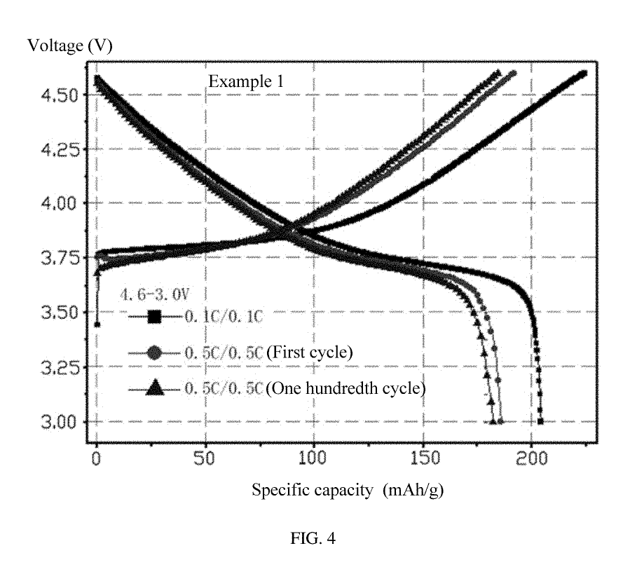

Referring to FIG. 4, the lithium ion battery of Example 1 is galvanostatically charged and discharged between 3.0 V and 4.6 V at different current densities, that is the battery is charged at 0.1 C then discharged at 0.1 C, and charged at 0.5 C and then discharged at 0.5 C. It can be seen from FIG. 4 that the lithium ion battery discharged at high current density still has a high specific capacity, and has a relatively small capacity loss after 100 cycles showing an excellent capacity retention.

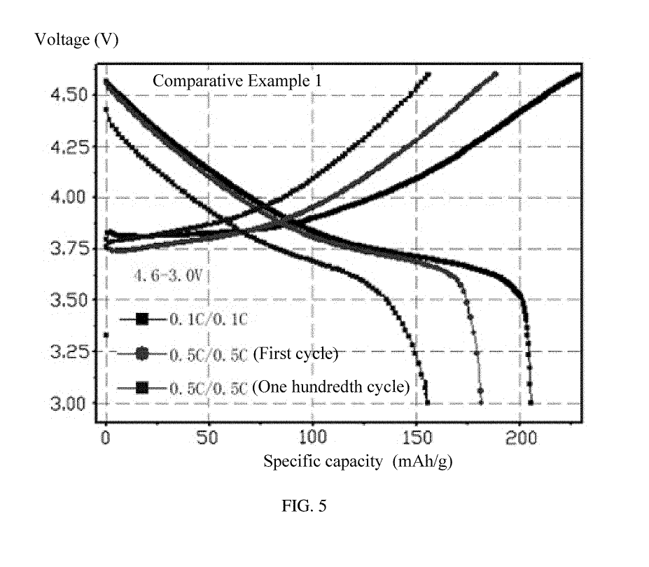

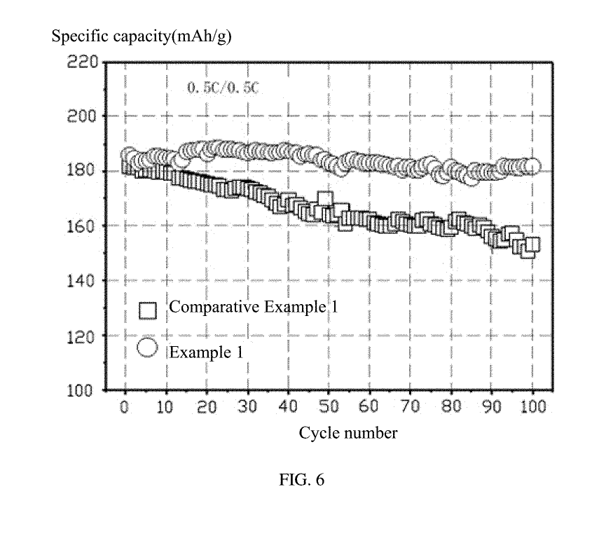

Referring to FIG. 5 and FIG. 6, the lithium ion battery of Comparative Example 1 is galvanostatically charged and discharged at the same condition with the lithium ion battery of Example 1. It can be seen that the discharge specific capacity of the lithium ion battery significantly decreases after the battery is charged and discharged at high discharge current density over 100 cycles, showing a poor capacity retention of the battery. It can be concluded that the coating layer on the cathode active material can significantly improve the capacity retention of the cathode active material and greatly improve the electrochemical performance of the lithium ion battery.

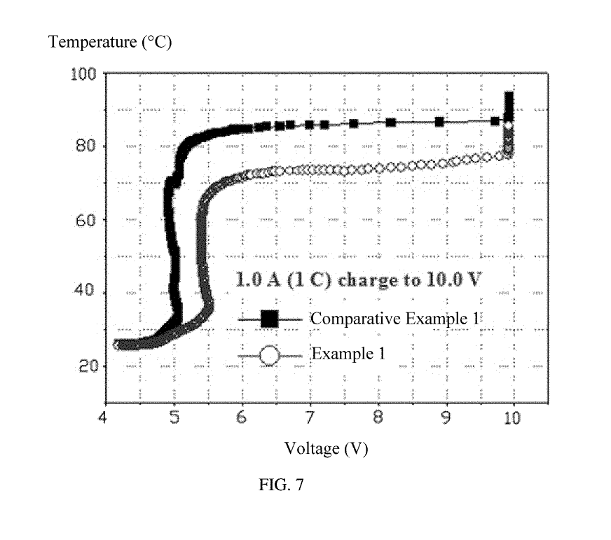

Referring to FIG. 7, the lithium ion batteries of Example 1 and Comparative Example 1 are overcharged. More specifically, the lithium ion batteries are respectively charged at a current 1.0 A till the voltage reaches 10.0 V, during which temperatures of the lithium ion batteries are measured. It can be seen that the temperature of lithium ion battery in Example 1 is lower than that of Comparative Example 1.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A coating liquid for a cathode active material, the coating liquid comprising a solvent and a phosphate salt coating precursor soluble to the solvent, wherein
the solvent comprises an alcoholic solvent, and
the phosphate salt coating precursor is capable of producing under heating a phosphate salt having a general formula of AlₘMₙPO₄, wherein M has a valence state of k and represents one or more alkaline earth metal elements or transition metal elements, 0≤m<1, 0<n≤1, and 3m+kn=3.

2. The coating liquid of claim 1, wherein M is selected from the group consisting of trivalent Cr, trivalent Fe, bivalent Sn, bivalent Ni, bivalent Co, bivalent Cu, bivalent Mn, tetravalent Zr, tetravalent Ti, and combinations thereof.

3. The coating liquid of claim 1, wherein a molar ratio of P:(Al+M) in the phosphate salt is in a range from about 4:3 to about 2:3.

4. The coating liquid of claim 1, wherein the phosphate salt is selected from the group consisting of (Al₁₋ₓMg_{x/2}Ti_{x/2})PO₄, (Al_{1-y}Mg_{3y/2})PO₄, (Al_{1-z}Ti_{3z/4})PO₄, and combinations thereof, 0<x≤1, 0<y≤1, and 0<z≤1.

5. The coating liquid of claim 1, wherein the alcoholic solvent is selected from the group consisting of methoxy, ethoxy, propoxy, butoxy, isopropoxy, and combinations thereof.

6. The coating liquid of claim 1, wherein a pH value of the coating liquid is in a range from about 6 to about 7.

7. The coating liquid of claim 1, wherein the phosphate salt coating precursor comprises at least one of a first coordination complex represented by formula (I-I) and a second coordination complex represented by formula (I-II),

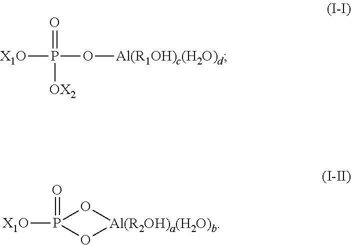

8. The coating liquid of claim 7, wherein the R₁OH and the R₂OH are alcoholic solvent molecules; c is 1 to 5, d is 0 to 4, and c+d=5; a is 1 to 4, b is 0 to 3, and a+b=4, —OX₁ and —OX₂ are an —OH group or an alkoxy group.

9. The coating liquid of claim 7, wherein the R₁OH and the R₂OH are each selected from the group consisting of methanol, ethanol, propanol, n-butanol, isopropanol, and combinations thereof; —OX₁ and the —OX₂ are each selected from the group consisting of —OH, methoxy, ethoxy, propoxy, butoxy, isopropoxy, and combinations thereof.

10. The coating liquid of claim 7, wherein the phosphate salt coating precursor comprises at least one of a third coordination complex represented by the formula (I-I) except Al is substituted by M and a fourth coordination complex represented by the formula (I-II) except Al is substituted by M.

11. A coating liquid for a cathode active material, the coating liquid being a homogeneous clear solution comprising:
a mixture of a phosphate ester, an aluminum salt, a modifying element containing compound, and an alcoholic solvent; or
a mixture of at least one of phosphoric acid and phosphorus pentoxide, the aluminum salt, the modifying element containing compound, and the alcoholic solvent.

12. A method for making a coating liquid for a cathode active material, comprising:
forming a phosphate ester solution by adding a phosphate ester in an alcoholic solvent; and
adding an aluminum salt and a modifying element containing compound in the phosphate ester solution, wherein the aluminum salt and the modifying element containing compound are soluble to the alcoholic solvent, and react with the phosphate ester to form a homogeneous clear solution.

13. The method of claim 12, wherein the first alcoholic solvent is selected from the group consisting of methoxy, ethoxy, propoxy, butoxyl, isopropoxy, and combinations thereof.

14. The method of claim 12, wherein the phosphate ester is selected the group consisting of from methyl phosphate, dimethyl phosphate, trimethyl phosphate, ethyl phosphate, diethyl phosphate, triethyl phosphate, butyl phosphate, dibutyl phosphate, tributyl phosphate, isopropyl phosphate, di-isopropyl phosphate, tri-isopropyl phosphate, and combinations thereof.

15. The method of claim 12, wherein the aluminum salt is selected from the group consisting of aluminum chloride, aluminum nitrate, aluminum isopropoxide, aluminum lactate, and combinations thereof, and the second compound is selected from the group consisting of magnesium nitrate, nickel nitrate, manganese nitrate, cobalt nitrate, magnesium acetate, nickel acetate, cobalt acetate, manganese acetate, zinc chloride, copper nitrate, tetrabutyl zirconate, tetrabutyl titanate, and combinations thereof.

16. The method of claim 12, wherein M has a valence state of k and represents one or more alkaline earth metal elements or transition metal elements; a molar ratio of P in the phosphate ester to a total of Al in the aluminum salt and M in the modifying element containing compound is in a range from about 4:3 to about 2:3.

17. The method of claim 12, wherein a molar ratio of the modifying element containing compound to the aluminum salt is in a range from about 10:1 to about 1:10.

18. The method of claim 12, wherein adding the aluminum salt and the modifying element containing compound in the phosphate ester solution comprises:
adding the aluminum salt and the modifying element containing compound into a second alcoholic solvent, thereby obtaining a mixture solution containing the aluminum salt and the modifying element containing compound; and
mixing the mixture solution with the phosphate ester solution to react the aluminum salt and the modifying element containing compound with the phosphate ester to form the homogeneous clear solution.

19. The method of claim 12, further comprising:
regulating a pH value of the homogeneous clear solution to a range from about 6 to about 7.

20. The method of claim 12, wherein forming the phosphate ester solution by adding the phosphate ester in the alcoholic solvent further comprises:
adding at least one of phosphoric acid and phosphorus pentoxide into the first alcoholic solvent; and
forming the phosphate ester by reacting the at least one of phosphoric acid and phosphorus pentoxide with the first alcoholic solvent at a temperature in a range from about 0° C. to about 80° C.
